(19) United States
(12) Patent Application Publication
(10) Pub. No.: US 2005/0162257 A1
(43) Pub. Date: Jul. 28, 2005

(54) System of electronic devices that is designed to assist a football referee

(76) Inventor: Harold H. Gonzalez, Washington, DC (US)

Correspondence Address: Harold H Gonzalez, 228 3rd Street N E, Apt # 3, Washington, DC, 20002, US

(21) Appl. No.: 10/505,712

(22) PCT Filed: Feb. 20, 2003
(86) PCT No.: PCT/IB03/01012

(51) Int. Cl. G08B 23/00

(52) U.S. Cl. 340/323 R; 377/5

(57) ABSTRACT

The invention relates to a system of devices that can be integrated into elements that are designed to assist the referee in football, such as the referee's whistle, the linesmen's flags, the playing area and the ball. The inventive system can also be used for American football and for any other ball sports. The invention makes use of a series of sensor elements, LEDs (light-emitting diodes) or indicator bulbs, vibration indicators, a control console, a laser light and radiofrequency signal transmitter/receiver mechanisms together with the respective microchips thereof, all of which are known in electronics. The aforementioned elements are adapted and used as auxiliary refereeing supports in the standard elements, i.e. the whistle, flags and rectangular playing area, and, in this way, can be used to provide instant correct solutions to playing situations that could give rise to dubious decisions and subsequent disputes.

### OBJECTIVE

The invention presented refers to a system of incorporated arbitration aid devices applicable to the game of soccer through the whistle or horn, the assistant referee's flags, the ball, and the field. (The invention is also applicable to American Football as well as all other sports that are played with a ball).

The invention uses a series of sensory elements, LEDs (Light Emitting Diodes) or indicator lights, vibrating indicators, a control panel, and radio frequency signals of emitting-receiving mechanisms with microchips, that when adapted and utilized as an arbitration aid in the basic elements of the whistle, flags, ball, and field of Play, provide instant and certain solutions to plays that usually cause doubts in judgment and conflicts.

Antecedents

Arbitration control of soccer is subject to errors by the referees because they lack aids that allow them to decide whit total accuracy. For example, if a player was “forward” a few centimeters to impose an “off side”, or if the ball passed the goal line by a few centimeters. For that reason (until now), in order to make a right or wrong decision, the referees depend on the position in which they happen to catch the play (according to the point of view they have at that very moment), with the unfair consequences that in a few occasions have occurred from having to repeat, for example an official game of the European championship, because the referee declared a non-existent goal (then as it was shown on television, the ball never passed through the goal line), or causing violent reactions by the fans or players (with horrible results such as injured people or even in the loss of life).

The solutions that have been tentatively considered, and are frequently presented to try to correct continuous and serious arbitration errors (still in the world-wide championships although the best referees of the world meet there) range from the inclusion of two additional referees (one behind each goal line) by specifically being in charge of supervising the plays that occur close to the penalty areas, to the possibility of using videos taken from different angles to review if the Referee was correct or not through the interpretation of each judge. However (with all reason), the International Board (the organization that governs the rules of soccer) has systematically refused to accept any type of aid “a posteriori” (that forces the game to stop every time there is a doubtful play, in order to check on one or several television screens to see if the Referee was correct or not) which clearly would slow down the rhythm of the game; on the other hand, the first option is difficult and unpractical, in addition to having to adapt changes in the rules of the game, two additional referees would have to be incorporated.

This invention, however, allows the referees to have at their disposal an aid that is as fast as it is precise so that the referees do not need to stop the game to review a video to make a decision. They simply pay attention to the change in signals that are instantly provided to both the whistle and the flags (elements of this invention by which the referees can control the game). It does not require a single change in the rules of the game, since both the referees and the assistant referees will continue performing the exact same tasks as they do today, but they will have instant assistance to avoid mistakes.

With this invention, the referees are able to control, with complete accuracy, ten different situations during the development of a soccer game, including the most complicated: For example, they can determine if the ball passed the goal line by millimeters, so they can signals the respective point with total certainty, even though during the moment of the play the referee found himself without full vision of the goal line. Also, it can determine if an attacking player was found “in line” or “forward” by a few millimeters at the exact moment the ball is passed to one of their team mates, (it does not matter if the referee or assistant referee reacts a few seconds after the mentioned pass) this way the referees can signal or call the respective “offside” immediately and without danger of making a mistake, even though the offside play caught them off guard.

With this invention, one can also determine, for example, if a defense player irregularly invaded the 9.15 mts. area that should remain free to opposing players at the time of a “free kick,” and obtain an indication of how many centimeters the player “invaded” the area, etc.

### DESCRIPTION

In order to control with total accuracy and immediacy the ten game situations previously mentioned, the invention establishes a system of five types of electronic aid devices as follows:
A. Hand Held Devices
   A-1 THE WHISTLE (used by the Referee)
   A-2 THE FLAGS (used by the Assistant Referee)
B. Mobile Position Sensors to determine the relative positions on the field (they emit radio frequency signals)
   B-1 MOBILE POSITION SENSOR FOR THE BALL (goes within the ball)
   B-2 MOBILE POSITION SENSORS FOR THE PLAYERS (each player wears one in the belt of his uniform)
C. Field Devices (they are emitter-receiver radio frequency signals)
   C-1 FIXED AERIAL UNITS, are four receiving units of emitted signals by the MOBILE POSITION SENSORS (the four units are installed optionally, aerially and equidistant, to about 3 mts. high on the “touch lines” of the field).
   C-2 FIXED GROUND UNIT, is a receiving and transmitting devises of information between the Control Panel and the Hand Held Devices, (functions as an antenna through which the CONTROL PANEL emits and receives signals to the HAND HELD DEVICE of the Referees and vice versa). The optional location of the FIXED GROUND UNIT is about five centimeters beneath the level of the field, at the point that marks the exact center of the field.
   C-3 FIXED GOAL LINE UNITS, are four receiving units of signals emitted by the ball, and allows accurate detection the moment that the ball passes the goal line. The four units are optionally installed on the goalposts.
D. LASER LIGHT BEAM, is a laser light trigger that projects into the field a few lines that mark the exact distance of 9.15 metros that should remain free to opposing players during the free kicks.
   It simultaneously can project advertisements on the field during any moment of the game, especially during the recovery of “free kicks”.
   THE LASER LIGHT BEAM is going to be installed aerially, preferably above one of the stadium's light towers and it has a “spot light” mechanism, to automatically focus on the position of the ball in any place on the field where the a “free kick” is taken.
   The activation of the light beam that projects the LASER LIGHT BEAM is the responsibility of the Referee (through the activator button of the laser signal that he finds in his whistle). The projected signal on the field begins to dissipate once the ball has been “kicked” and it goes out totally, in optional form, 1.500 milliseconds after the respective kicked.
E. THE CONTROL PANEL, is made up of two parts:
   E-1 THE TIME DISCRIMINATOR
   E-2 A PERSONAL COMPUTER (PC)

This last one contains the software that interprets, controls, and “bounces” the different signals that are received from the mobile position sensors, just like the hand held devices, thanks to the field devices that serve to send and receive these signals.
THE CONTROL PANEL processes the information automatically and immediately, and instantly rebroadcasts it toward the hand held device that the referees handle.
THE CONTROL PANEL that is managed by a designated “Fourth Official,” is connected by means of Fiber Optic conductors (of identical length) to each of the nine field devices and from them it receives the information to be processed, but the transmission of its signals toward the hand held devices of the arbitrators, only makes it (wireless by radio frequency) through the field device designated FIXED GROUND UNIT, that for this purpose acts as an antenna (as already indicated, the fixed ground unit, is installed below the point that marks the exact center of the field).

The HAND HELD DEVICES of this invention indicate as much to the referee as to the assistant referees, instantaneously and with absolute precision in the following situations throughout the course of the game, that integrate the utility of this invention:
1. The invention detects if the ball does or does not pass the “goal's plan” (it also designates the “goal line”) to help the referee when a play appears doubtful, in the following manner:
   If the ball passes “the goal line,” immediately, before three microseconds (0.000003 seconds) passes, a micro frequency signal is sent from the control panel toward the referee's whistle, and the whistle automatically begins to emit a vibration signal so that only the referee and the fourth official, who handles the control panel receive that information (if the signal was auditory or illuminated, it would allow the players on the field to find out at the same time and it would encourage them to illegally “pressure” the referee when he has to abstain from penalizing the respective “goal” if through their judgment they consider that there appears to have been an invalid action in the previous play).
2. The invention detects if the ball did or did not pass the “touch line” (to penalize the corresponding “throw-in”). In this case, both the flag of the assistant referee of the respective side (accordingly the ball has left the jurisdiction of assistant referee number one or the jurisdiction of assistant referee number two), and the whistle of the referee and the control panel registers that the ball has gone out of bounds. The invention emits an auditory signal (like, beep-beep) to both the referee's whistle and the assistant referee's flag, to indicate that they should lift the flag to signal the respective “throw-in” call and indicate that the arbitration should proceed in order to resume the game from the from the recovery of the throw.
3. The invention detects if the ball does or does not pass the goal line to determine if the corner kick or goal kick is necessary. In this case, both the referee's whistle and assistant referee's flag of the corresponding jurisdiction emit an auditory signal (like, beep-beep), and at the same time an intermittent yellow colored LED begins to “blink” for the assistant referee, If required, he can directly verify with the flag, that the out of bounds has taken place by the goal line and not by the sideline. This way the referees have total certainty that the ball went out of the field by the goal line (even if its by millimeters), and consequently they should proceed to call the corresponding goal kick or corner kick, according to what is needed to resume the game.
4. The invention also detects if at the exact moment the ball touches or is played by one of his team, the most advanced attacking player was situated “forward” in relation to the penultimate defending player (to penalize with accuracy an “off-side”).
   In order to determine this, through its field devices, and especially through its time discriminator, each time the ball is kicked the invention determines (through triangulation) the position of the attacking player that is “forward,” not “in line,” or “behind,” and stores this information in the temporary memory system. At that moment the information, whether positive (if there was an off-side) or negative (when there was not such a situation), remains available for the assistant referee if he asks for it through the “trigger button” on his flag. Then, if at any moment during the game, the assistant referee wishes to verify if a situation of “off sides” has taken place, he simply presses the button on his flag and, in a case where the system has stored positive information that an “offside” has occurred, the system relays the corresponding signal to him: At that moment, both the assistant referee's flag and the referee's whistle begin to emit an auditory signal, like beep-beep (a different tone and frequency than the one for an out of bounds ball), that indicates to the assistant referee that he should lift his flag to signal an off-side. Just as the system knows which players are situated “offside” at the exact moment the ball is touched, it also reports that information to both the whistle of the referee and control panel, run by the fourth official, indicating the exact distance of the “forward” player.
   The most important part of this mechanism, is that it does not matter if the assistant referee takes one or several seconds to press the button to check if an “offside” has taken place (normally, the player's pass takes place first and then the assistant referee reacts), that lapse in time can mean an erroneous offside is detected, because the players are moving and in a fraction of a second can change their positions on the field play. However, this mechanisms detects the “offside” position as soon as the ball is kicked (at the exact moment the pass starts off towards the teammate), but only transmits this information if the assistant referee asks for it through his trigger button, it does not matter if the assistant referee waits one or two seconds to active the button on his flag. This invention brings justice to the regulation and finally solves an old problem in soccer, that many, many times is shown through television, causing the referees and assistant referee to slowly penalize the offside situation.
5. Once it detects that the attacking player was situated “forward” at the exact moment he passed the ball to his teammate, the invention detects if the path of the ball was positive or negative (whether it goes towards the rival arch or backwards), so it can ratify the “offside” sanction (if the path is positive) or in its defect cancels the prior numeral signal. (The regulation clearly indicates that if the “pass” happens “horizontally” or “backwards,” it does not matter if the receiving player is found “forward” in relation to the penultimate defender and in this case should not be penalized for an offside.) In this case, neither the referee's whistle nor the assistant referee's flag signals an auditory sound, but the control panel reports the situation as “not off-side”.
6. The invention also provides a clear visual marking (through a LASER illumination device, activated by the referee's whistle) of the 9.15 meter distance around the ball the should remain free of opposing players at the moment a “free kick” is taken, when it has been requested by the “attacking” team.
   This LASER light device provides, simultaneously, to project combined with the free distance signal of 9.15, an incidental advertising model, that has great impact on moments of tension during the game, because at that moment all eyes are focused on this section of the field in which for 20, 30 or more seconds the only action that occurs is the “wait” until the kick has been taken”
7. The invention detects if one or more players invade the area of 9.15 during the “free kick,” likewise, it detects which players committed the invasion for the resulting penalty corresponding to the time that indicates the distance in centimeters of the “invasion” and reports this information instantly to both the referee's whistle “display” and the control panel handled by the designated fourth official. In a case where one or more players invade a free area of 9.15 meters before the ball has been kicked, an auditory signal (like, beep-beep) will activate both the referee's whistle and the assistant referee of the respective jurisdiction's flag.
8. The invention detects which players invade the designated “penalty area” (of 16.50 meters) during the “penalty kick” so that in an affirmative case, the referee can determine with total certainty that it is necessary to repeat the kick as the rules of the game order state. At the same time, the invention indicates the distance in centimeters of the “invasion” and instantly registers it in both the “display” of the referee's whistle and the control panel handled by the designated “fourth official.” In a situation where one or more players invades the free area of 16.50 meters before the ball has been kicked, an auditory signal (like, beep-beep) will activate in both the referee's whistle and the assistant referee of the respective jurisdiction's flag.
9. The invention detects if the goalkeeper moves before the attacking player has kicked the ball during a “penalty” kick to determine if he has to repeat the kick, as ordered by game regulations, indicating the distance of the illegal move, and registering it in both the “display” of the referee's whistle and the control panel. In a case where the goalkeeper moves before the ball has been kicked, an auditory signal (like, beep-beep but of a different tone and frequency than the auditory signal of an area invasion) activates both the whistle of the referee and the assistant referee's flag in the respective jurisdiction, likewise in the referee's whistle an intermittent red colored LED activates which begins to “blink” immediately when the situation appears anomalous.
10. The invention carries on the accounting of “yellow cards” of the match, by means of applying the “red card” when a player accumulates two “yellow cards.” In a case where a player receives two yellow cards, an auditory signal (such as, beep-beep) activates the Referee's whistle, at the same time that a red colored LED begins to “blink,” indicating that the player should be expelled from the field.
11. The invention allows the referee to be automatically aware when there are two balls on the field in order to take corrective measures.
12. The invention allows the assistant referee to activate a call signal (like, beep-beep) to the referee to announce a change in players or to inform him of a disciplinary infraction committed by a player or any such anomaly displayed by player substitutes or staff of the team.
13. The invention allows the referee and fourth official to control the time played, excess time, time during which the game has been interrupted, and the time left to finish the game, just as it allows the referee to announce the time that should be added as the end of the game approaches.

To be able to emit the corresponding signals and indications so that the referees can rely on this excellent tool at the time of crucial decisions throughout the course of the game, the HAND HELD DEVICES (the WHISTLE the referee carries and the FLAGS the assistant referee use) receive pertinent indications from the control panel.

The CONTROL PANEL receives the information at the same time as the Mobile Sensor Positions (through eight field devices designated FIXED AIR UNITS and FIXED GOAL LINE UNITS) and it instantly processes, interprets, and bounces this information back, to immediately send signals (by radio frequency) back towards the Hand Held Devices through the field devices designated FIXED LAND UNITS (which, as already indicated, are going to be installed below the point that exactly marks the center of the field and at the same time are connected to the CONTROL PANEL, through a fiber optic conductor).

The FIXED AIR UNITS (optional, each two milliseconds) detect the relative positions on the field of each one of the 22 players as well as the position of the ball anywhere on the field, thanks to the signals the devices emit that are built into the ball and carried on each one of the players (the MOBILE POSITION SENSOR). With this information, the control panel can check the exact position of each player, optionally, every two milliseconds (0.002 seconds) and the exact position of the ball, optionally, every three microseconds (0.000003), throughout the development of the game.

Finally, the control panel that is handled by the designated “fourth official,” not only registers and controls the chronological information (time elapsed, time interrupted, time left, time added, etc.) but also records an electronic log of the game's incidents which updates the most important moments and plays of the game, with their respective time and arbitration decision. Likewise permit to announce to the referee (by microwave through the whistle), the time that should be added at the end of each game, and the accounting of the yellow cards so that when a referee is going to warn a player he can be reminded it he already has a yellow card, in such a way that by card accumulation that player must be expelled from the field play.

One of the most important functions of the software installed in the control panel, is its mechanism to “shield” against possible external attack attempts by third parties with “electronic noise,” thanks to the transmission of each one of the radio frequency signals between the different devices of the invention, that are randomly coded by software: The assignment of Transmission Codes, before the start of each game, to each one of the invention's devices, that are internally coded, allows each one of the 26 devices in movement (the 22 players, plus the ball, the whistle, and the two flags) to communicate with the control panel in a way that can independently identify each one of them.

Because the system uses more than a million different storable codes (of which only 26 of the codes randomly assigned by the software are used, but before each game), it prevents the possibility that scrupulous hands could attack the system with the intention of producing interference in its functions during any moment of the game. To do this, they would not only need to know what the transmission frequencies of the different devices but also the transmission codes for each one.

If one keeps in mind that the assigned transmission codes can be modified (again at random and by software), from the control panel at any moment of the game, then one can be certain that the system is completely protected against attempts to bombard it with “electronic noise” from fans or people placing bets on the game.

When a new player is going to enter the field, they should first report to the control panel, where electronically, they are assigned one of the more than 1,000,000 codes not yet available in the system.

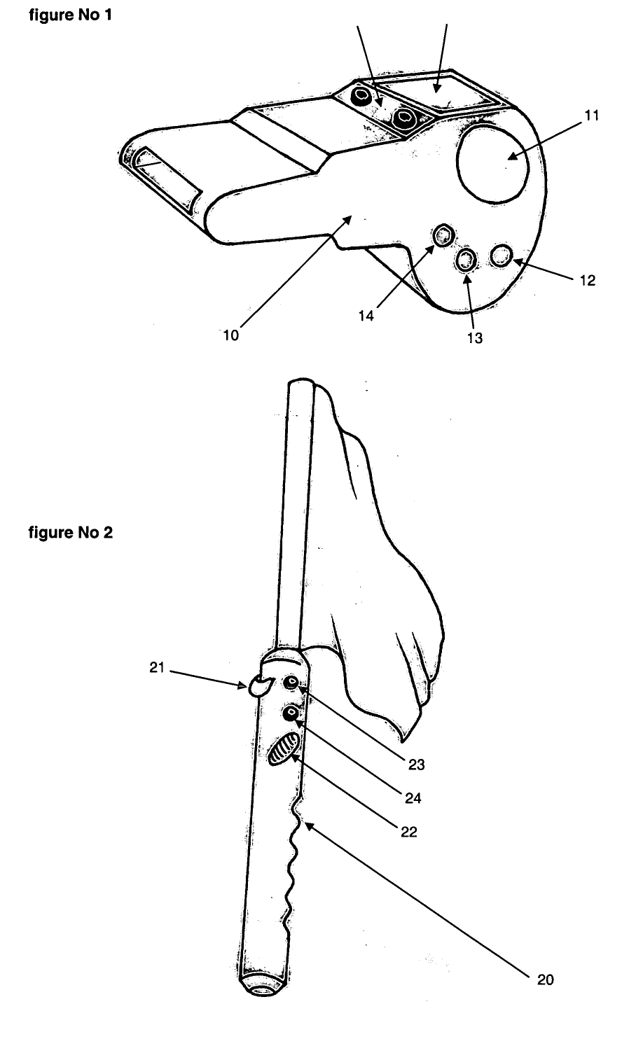

FIGS. 1 to 4 illustrate the field aids of the invention:

FIG. 1 Shows the horn or whistle of the referee, with the elements of the invention built-in;

FIG. 2 Shows the assistant referee's flag, with the elements of the invention built-in;

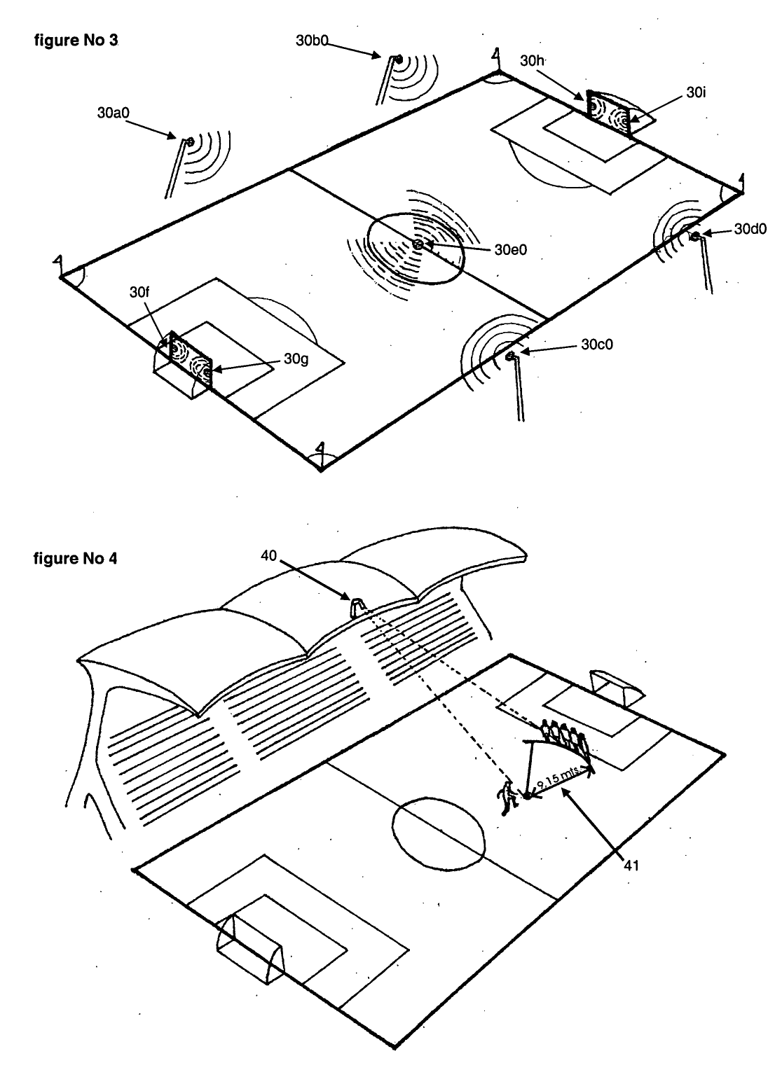

FIG. 3 Shows schematically the optional location of the field devices on the field;

FIG. 4 Shows schematically the optional location of the LASER light beam in a high part of the stadium, and also shows the 9.15 meter free distance illumination sign that the LASER light beam projects on to the field at the time of a “free kick;”

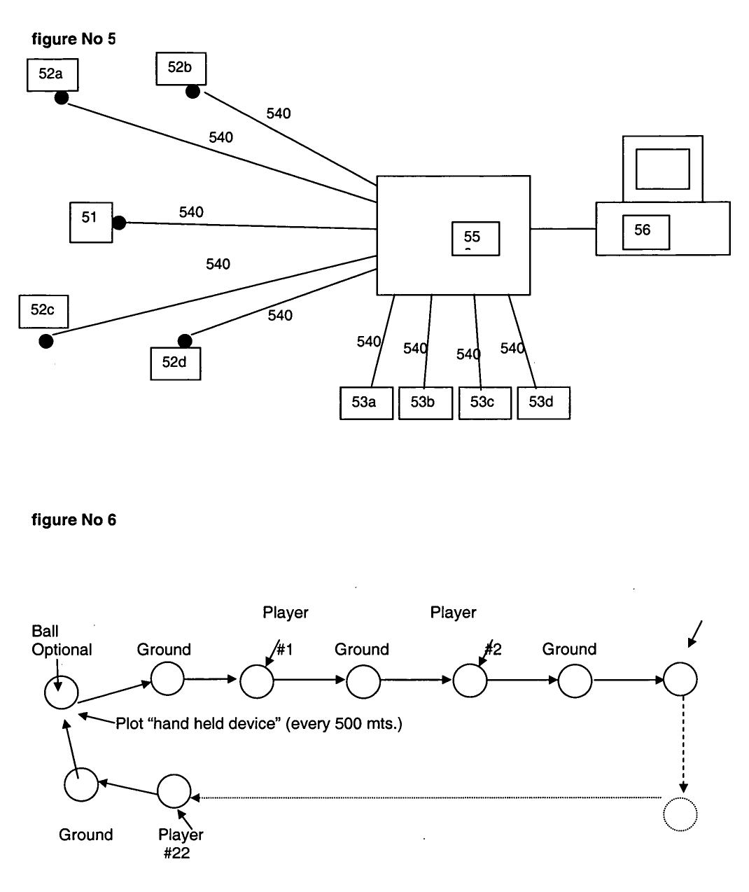

FIGS. 5, 6, 7, and 8 illustrate the scope of the invention's electronic system:

FIG. 5 Represents a diagram of the invention's electronic system, in which both the Fixed Land Unit (51), and the Fixed Aerial Unit (52a, 52b, 52c, and 52d), as well as the Fixed Goal Line Unit (53a, 53b, 53c, and 53d), are connect by fiber optics (54) to the Time Discriminator (55) which is connected to a personal computer (56). These last two devices (the time discriminator and the personal computer) with their respective software comprise the control panel;

FIG. 6 Represents a diagram of the invention's electronic system's “cycle of consultation;”

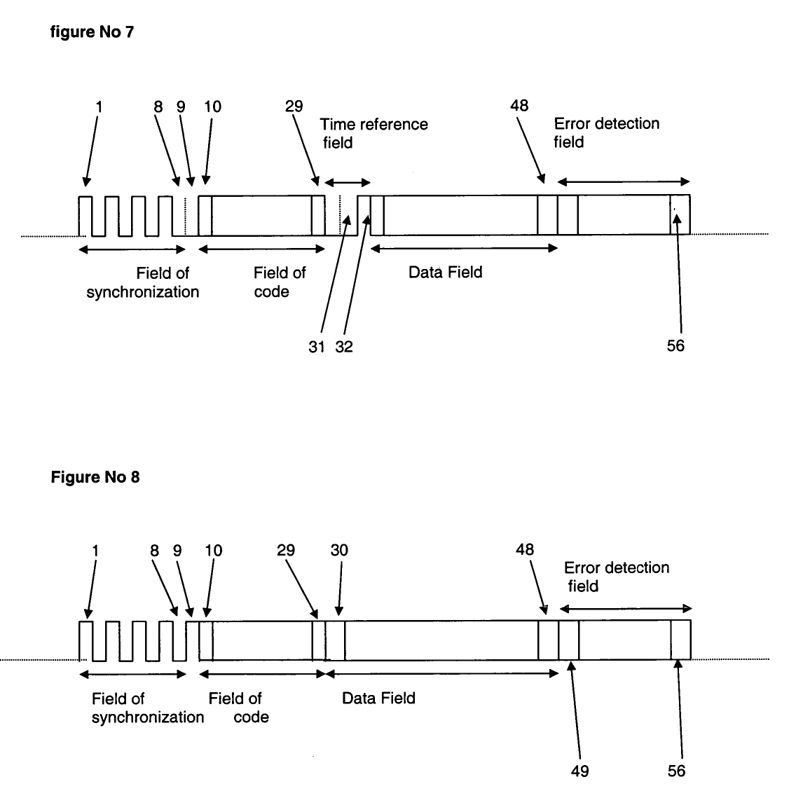

FIG. 7 Represents the “scheme” of a mobile position sensor (whether for the ball or the players);

FIG. 8 Represents the “scheme” of a hand held device (whether for the whistle or the flags).

### DESCRIPTON OF THE ELECTRONIC SYSTEM'S PERFORMANCE

The invention functions through a system of microwave radio-communications. The spatial positioning of each one of the “mobile position sensors” is determined by the time difference that exists in the four “fixed aerial units” as well as in the four “fixed goal line units,” in the reception of the radio emitted signal by any of the “mobile position sensors.”

So that the precision in determining the spatial position of the ball is better than 0.1 cm. and 1.5 cm. for the players, the radio systems can operate on an equal or superior frequency to those of 10 GHz (10 GHz=10,000,000,000 cycles per second), and the fixed length of the transmitted plot should not be larger than 56 bits.

The difference in time between the signals is calculated by an electronic devised called the “time discriminator,” which receives the originating signals from the “fixed aerial units,” takes the first arriving signal as reference, and with the three remaining, calculates the spatial position using the traditional method of triangulation.

For the specific case of the game of GOAL use the two fixed aerial units installed in the goal and the two closest fixed aerial units on the field.

So this system functions adequately, each “position sensor” should transmit its signal without interfering with the others, since it uses a single channel with sufficient bandwidth to transmit 2 Mbps. To achieve this, it is necessary to establish what moment each of the “position sensors” transmits.

The “fixed land unit” emits a synchronization signal (that at the same time carries the information for the flags and whistle). The cycle begins when the “fixed land unit” indicates to player #1 that it transmits his signal. All of the “mobile position units” are also receptors that are able “listen” to the signal and able to transmit the signal that corresponds them. After player #1 has finalized his transmission, the “fixed land unit” sends a signal so that it transmits to player #2. For both players, the “fixed land unit” asks for transmissions to the ball. This process repeats through player #22 and this cycle is executed indefinitely and should last less then 2 milliseconds (2 ms.). (FIG. 6 schematically represents this “consultation cycle.”)

Description of the Time Discriminator:

The “mobile position sensors” (both the position sensor of the ball and the position sensors of each player), emit a microwave radio signal that arrives at a different time to each of the “fixed aerial units.” At this point, the radio signals convert to optic signals that are transported by fiber optics to the Time Discriminator. If the broadcast velocity of the optic signals is the same for each one of the fibers, these should be the same length to conserve the difference in time of the signals.

The “Time Discriminator” device is an electronic apparatus that has very fast CPU and memory able to process digital and analog signals at a high rate, should be able to calculate differences in time by 50 Pico seconds (1 ps.=0.000000000001 second), and able to provide processed information to a personal computer using a USB port. This personal computer (PC) should use an operating system in real time (RTOS). The “Time Discriminator” also receives and emits signals through the “fixed land unit” (which is connected by fiber optics) to control the transmissions of the “mobile position sensors” and send and receive messages from the “hand held devices” that the referees use.

Description of the Structure for the Network of Information:

The “network of information” is the chain of bits transmitted and received by any transmitter or receiver element of the system. Two networks, in particular, exist for this application:

1. Network for the “Mobile Position Sensor”

The fields that compose the network for the “mobile position sensor” are:
a). Synchronization field: Serves to synchronize the clock of the bit in the receptors. There are bits 1 to 8 and bits 1, 3, 5, and 7 that are in “1” logical and bits 2, 4, 6, and 8 that are in “0” logical.
b). Network Bit Type: The 9 Bit identifies the type of network. In this case “0” is the logical for the “mobile position sensor” network.
c). Code Field: Is a field of 20 bits that identifies each one of the “mobile position sensors” and recognizes up to 1,048,574 different codes. It can assign each sensor and change any moment. It reciprocates bits 10 to 29 of the network.
d). Time Reference Field: This field is where the time signal is taken for each one of the emitted networks for the “mobile position sensors.” It is the most important part of the network. Bits 30 and 31 should remain in logical “0” and bit 32 should remain in logical “1.” The ascent line between bit 31 and 32 is the clock's trigger in the “Time Discriminator,” which should have a resolution of 52 Pico seconds.
e). Data Field: It is a field that has 16 bits to be used freely as user data. They can be used to accumulate yellow cards for the players, the name of the player, data on the balls acceleration, data on the ball crossing the field to detect a goal, goal kicks, sidelines, and much more. It can code 65,534 different messages.
f). Error Detection Field: It is a field of 8 bits that is used to detect any error in the signal transmission process. If the “Time Discriminator” detects a transmission error, it should repeat the transmission request until the signal arrives correctly (it has a limited number of attempts).
   2. Network for “Hand Held Device:”

These networks do not use the “fixed aerial units.” They are used to interchange data between the “Time Discriminator” and the “hand held devices” through the “fixed land unit.” The structure of this network is similar to that of the “mobile position sensors” to assure compatibility with the telecommunications system. The difference is the value of the type of bit network and the absence of the time reference field that in this case is not necessary, and the bits cross the user data field.

The fields that make up the network for the “hand held device” are:
a). Synchronization field: The same as the network for the “mobile position sensor.”
b). Network Bit Type: In this case, bit 9 is always logical “1.”
c). Code Field: The same as the network for the “mobile position sensor.” In this case the code users are the whistle, the flags, and the “fixed ground unit” equivalent to the “control panel.”
d). Data Field: It is 19 bits. If bit 30 is a “0” logical it is a matter of a transmission from the control panel and if it is a “1” logical it is a transmission from the whistle or one of the flags.
e). Error Detection Field: The same as the “mobile position sensor” network.

It is not necessary to include this type of network in the consultation cycle of the “mobile position sensors” because it only transmits when necessary. In this case, since the “fixed land unit” is what controls the transmission process, it can send and request a transmission towards or from the whistle or any flag before it begins a new consultation cycle from the “mobile position sensors.” Because the speed of the transmissions and the number of bits are the same for both types of networks, inserting a message before they begin a new consultation cycle does not impact the precision of the spatial positing of the ball or players. The networks of the hand held device can insert a message every 500 milliseconds (500 ms.).

As for the arbitral hand aids, the whistle (FIG. 1) used by the referee, is a conventional whistle (10) with a radio-frequency emitter-receiver that functions with two 1.5 volt compact batteries and also contains an activator button (11) for the “9.15 mts. free distance” LASER signal for when a “barrier” is requested during free kicks (as indicated previously, it is a light beam shot from a SPOTLIGHT and it has three main light bulbs; a green (12), a yellow (13), and a red (14) that indicate the respective GOAL, THROW-IN, OFFSIDES, and FREE KICK or CORNER KICK). It also emits an auditory signal, such as beep-beep (for when it receives a call from one of the assistant referee) and a vibration signal to inform the referee that the ball passed the “goal line.” Finally, it has an 8 digit “display” (15) divided into two sections (superior and inferior) in which the chronometric information appears or the yellow cards accumulated by each player. It also indicates the number of players that were “offside” at the moment the assistant referee actives the order to check for any “offside” (from a button on his flag). The “display” also indicates which players invaded the 9.15 free area during a free kick or the 16.50 area during a penalty kick. Similarly, the whistle has some buttons to control the games' time clock.

Each flag (used by the assistant referee) is a conventional flag equipped with a radio-frequency emitter-receiver, that functions with two 1.5 volt compact batteries. The flag has a trigger button whose activation causes the control panel to instantly check if an “offside” has occurred. The flag includes an “answer LED” accompanied by a beep-beep sound, which indicate to the assistant referee if indeed a player was “forward” at the moment he began a “pass” the ball to his teammate (this way the assistant referee has two ways to recognize an “offside:” he consults the LED or listens for the beep-beep and then raises his flag). The flag also has a button to call the referee.

FIG. 2 displays a flag (20) with a button (21) that activates a retractable mechanism to close the flag, a trigger button (22) that activates the order to check for any “offside” situation, a LED (23) that shows the position of the “offside,” and a call button (24) that emits a call signal to the referee (to indicate infractions, changes of players, reentries, game time, and other incidents).

The FIELD DEVICES (FIG. 3) work with radio-frequency signals, connected to the control panel by means of individual fiber optic cables that can be arranged as follows:
C-1 The FIXED AERIAL UNIT, four are (30a, 30b, 30c, and 30d0 installed aerially and equidistant, towards the sidelines of the field.
C-2 The FIXED LAND UNIT, (30e) is installed 5 cmts. below the ground level of the field, at the exact central point.
C-3 The FIXED GOAL UNIT, four are (30f, 30g, 30h, and 30i) optionally installed on the goal posts.

The optional location of the LASER LIGHT BEAM (40) is shown in FIG. 4 (installed in an elevated part of the stadium, preferably on one of the light towers), the sign projected (41) is in plain view during free kicks.

Finally, using the already mentioned field devices, the mobile position sensors, and the laser light beam, the invention allows the following innovations to generate revenue during the games television broadcast:
1. To automatically follow the balls trajectory with the cameras, in a way that when the television producer wishes, the ball always remains in a certain sector of the screen independent of its position on the field or the speed that it reaches during a play.
2. To avoid the floating advertising guidelines, placed by advertisers during the soccer games' broadcast, that cover the trajectory of the ball (this happens too often, causing the spectator to look unfavorable on the ad or product announced rather than favorable.
3. The most important: it allows for the installation of a VIRTUAL ADVERTISEMENT, so that viewers watching certain plays see the advertisements “projected” in certain areas on the field, even though those ads are not “physically” present on the field.

To achieve this, the MOBILE POSITIONING SENSOR OF THE BALL (that goes within the ball), emits a “pursuer” type signal (the same one that “focuses” the direction of the LASER light beam to visually mark the 9.15 distance during a “free kick”); the one that is also processed by the control panel to send it towards one or several television cameras, which are designed in a way to automatically follow the trajectory of the ball without the risk of losing a view during certain plays (which happens frequently during the broadcast of soccer games, especially when something in the foreground obstructs the view of the camera).

At the same time, at any moment the control panel can emit towards the television transmission system a positioning signal from a certain sector of the field so that on the television screen a previously recorded advertisement can be seen, but it will appear as if it were virtually painted on some section of the field (what is interesting is that, that signal is only seen on the television set in such a way that each television station and each country where the game is broadcast can see a “local” or “personalized” ad projected by the station that does the broadcast, obtaining with it a diversification of the ad offer that will allow many other new advertisers to support soccer at much more reasonable costs):

The important thing is that the field devices can be taken advantage of to allow the advertisements to remain on the desired section of the field, even if the camera or the players move (unlike present systems that can only show a fixed image on a certain place on the field).

The position sensors, indicator lights (LEDS), illuminated, LASER, auditory and vibration signals, the control panel and its respective radio-frequency emitter-receiver mechanisms, as well as the integrated “micro-chips” that these devices contain, and the fiber optic conductors, all already exist in the current technology. The true novelty of this invention is its very nature. It successfully reaches the root of the most common and delicate problems that always occur during soccer games.

Therefore, the extent of the invention is defined in the following vindication:

### SUMMARY

The invention presented refers to a system of incorporated arbitration aid devices applicable to the game of soccer through the whistle or horn, the assistant referee's flags, the ball, and the field. (The invention is also applicable to American Football as well as all other sports that are played with a ball).

The invention uses a series of sensory elements, LEDs (Light Emitting Diodes) or indicator lights, vibrating indicators, a control panel, and radio frequency signals of emitting-receiving mechanisms with microchips, that when adapted and utilized as an arbitration aid in the basic elements of the whistle, flags, ball, and field of the game, provide instant and certain solutions to plays that usually cause doubts in judgment and conflicts.

1. The system of electronic devices acts as auxiliary arbitrators for soccer games, and function through radio-frequency signal emitter-receiver mechanisms, which are located in:
The horn or whistle of the referee,
The flags of the Assistant referee,
The ball,
The field,
The player's uniforms,
A control panel and,
A LASER light beam.

2. According to claim number one, the system utilizes a control panel, which includes software or a program that interprets and transmits different emitted signals by the devices on the field, towards the devices in the whistle and the assistant referee's flags.

3. According to claim number one, the location where the electronic devices in the referee's whistle especially correspond to:
A radio-frequency emitter-receiver activated by batteries
A LASER signal activator button to mark the 9.15 meter distance for free kicks.
Three illuminated signals (green, yellow and red) to indicate different plays.
A display or screen with an 8-digit capacity to register game incidents or time passed.
Buttons to control the games' time clock.
A call button to call the attention of the Assistant referee
Internal vibrator to indicate a goal situation when the ball passes the goal line.

4. According to claim number one, the location of the electronic devices in each of the assistant referee's flags, corresponds especially to:
A button that retracts the flag into its mast.
A button that activates the order to check for any “offside” position.
A light emitter (LED) that indicates the “offside” position.
An auditory signal, like beep-beep, to indicate the “offside” position.
A button to call the referee through the whistle.

5. According to claim number one, the field devices work with radio-frequency signals connected to the control panel which include:
Fixed Air Units, placed on land level and on the sidelines.
Fixed Goal Units, installed in the goal post.
Fixed Land Unit, situated some 5 centimeters below the center of the field.
LASER signal beam, that is optionally placed on the roof, in the stands, or on a light tower, in order to follow the trajectory of the ball at any location on the field.

6. According to claims 1, 2, 3, and 5, the LASER signal beam projects on the field an image, in plain view, that points out the exact 9.15 meter distance that should remain free of opposing players during a free kick.

7. According to claims 1, 2, 3, and 5, throughout the course of a soccer game, when a player is found in an “offside” position at the exact moment the ball touches or is played by one of his team, it is reported in the “display” of the referee's whistle, in the assistant referee's flag, and in the control panel, at the request of the assistant referee, who only has to press a button on his flag for the system to indicate if an “offside” situation occurred.

8. According to claims 1, 2, 3, and 5, when an opposing player invades the area of 9.15 meters during a free kick, it is immediately reported in the display of the referee's whistle and the control panel.

9. According to claim 1, 2, 3, and 5, when a player invades the area of 16.50 meters during a penalty kick, it is immediately reported to the display of the referee's whistle and the control panel (in order to repeat the kick if necessary).

10. According to claims 1, 2, 3, and 5, during the execution of a penalty kick, when a goalie moves forward before the player has kicked the ball, it is immediately reported in the display of the referee's whistle and in the control panel (in order to repeat the kick if necessary).

11. According to claims one and two, the control panel is connected by fiber optic conductors of identical length to each on of the field devices (with the four fixed aerial units, the fixed goal units, as well as with the fixed land unit that acts as an antenna).

12. According to claims 1, 2, and 10, the transmission between the control panel and the hand held devices of the arbitrators (the whistle and the flags) is wireless by radio-frequency through the field devices (the fixed land unit).

13. According to claims one and two, the control panel incorporates software that, before the beginning of the game (or at any moment in the game), assigns random codes to each moving object (players, whistle, flags, and the ball) to avoid possible interference from third parties.

14. One system of electronic devices that incorporates in the control panel one time discriminator device, which receives signals from the fixed air units, as well as the fixed goal units, takes the first signal that arrives as reference and with the rest, manages to instantly calculate the exact spatial positioning of each one of the mobile devices through triangulation.
